(19) United States
(12) Patent Application Publication
(10) Pub. No.: US 2015/0379853 A1
(43) Pub. Date: Dec. 31, 2015

(54) METHOD AND SYSTEM FOR SENSOR BASED MESSAGING

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E. K. de Antoni, Manila (PH); Scott Gill, Taguig (PH); Daniel Stellick, Geneva, IL (US)

(21) Appl. No.: 14/315,289

(22) Filed: Jun. 25, 2014

(51) Int. Cl. G08B 21/18; H04W 4/12; G08B 21/02

(52) U.S. Cl. CPC G08B 21/182; G08B 21/02; H04W 4/12

(57) ABSTRACT

Systems, apparatuses, and methods described herein are configured for monitoring and managing a plurality of sensors. The plurality of sensors may be fixed, mobile, or a combination thereof. In some embodiments, the monitoring and management of the sensors is facilitated via a graphical user interface.

### RELATED U.S. APPLICATIONS

This application is related to U.S. patent application Ser. No. 14/281,896 entitled “SENSOR BASED DETECTION SYSTEM”, by Joseph L. Gallo et al., (Attorney Docket No. 13-012-00-US), filed on 20 May 2014, which is incorporated by reference herein.

This application is related to U.S. patent application Ser. No. 14/281,901 entitled “SENSOR MANAGEMENT AND SENSOR ANALYTICS SYSTEM”, by Joseph L. Gallo et al., (Attorney Docket No. 13-013-00-US), filed on 20 May 2014, which is incorporated by reference herein.

This application is related to U.S. patent application Ser. No. ______ entitled “METHOD AND SYSTEM FOR REPRESENTING SENSOR ASSOCIATED DATA”, by Joseph L. Gallo et al., (Attorney Docket No. 13-014-00-US), filed on ______, which is incorporated by reference herein.

This application is related to U.S. patent application Ser. No. ______ entitled “PATH DETERMINATION OF A SENSOR BASED DETECTION SYSTEM”, by Joseph L. Gallo et al., (Attorney Docket No. 13-016-00-US), filed on ______, which is incorporated by reference herein.

This application is related to U.S. patent application Ser. No. ______ entitled “GRAPHICAL USER INTERFACE OF A SENSOR BASED DETECTION SYSTEM”, by Joseph L. Gallo et al., (Attorney Docket No. 13-017-00-US), filed on ______, which is incorporated by reference herein.

This application is related to U.S. patent application Ser. No. ______ entitled “GRAPHICAL USER INTERFACE FOR PATH DETERMINATION OF A SENSOR BASED DETECTION SYSTEM”, by Joseph L. Gallo et al., (Attorney Docket No. 13-018-00-US), filed on ______, which is incorporated by reference herein.

This application is related to U.S. patent application Ser. No. 14/281,904 entitled “EVENT MANAGEMENT SYSTEM FOR A SENSOR BASED DETECTION SYSTEM”, by Joseph L. Gallo et al. (Attorney Docket No. 13-020-00-US), filed on 20 May 2014, which is incorporated by reference herein.

This application is related to Philippines patent application Ser. No. 14/281,904 entitled “A DOMAIN AGNOSTIC METHOD AND SYSTEM FOR THE CAPTURE, STORAGE, AND ANALYSIS OF SENSOR READINGS”, by Ferdinand EK de Antoni, (Attorney Docket No. 13-027-00-PH), filed on 23 May 2013, which is incorporated by reference herein.

This application is related to U.S. patent application Ser. No. 14/281,904 entitled “USER QUERY AND GAUGE-READING RELATIONSHIPS”, by Ferdinand EK de Antoni (Attorney Docket No. 13-027-00-US) and filed on 21 May 2014, which is incorporated by reference herein.

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the information gathered is used for marketing and advertising to the end user, e.g., a smartphone user receives a coupon to a nearby Starbucks, etc., while the security of our community is left exposed and at a risk of terrorist attacks such as the Boston Marathon bombers.

### SUMMARY

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security.

Embodiments are configured for receiving sensor associated data (e.g., sensor raw data, analyzed sensor data, sensor metadata, etc.) and sending messages based on a condition (e.g., rule, parameter, heuristics) and the sensor associated data. Embodiments are further configured for formatting the messaging (e.g., based on a template) according to the destination of the message (e.g., Fusion Center). Embodiments may send human readable or machine readable messages.

One embodiment is directed to a method for monitoring and managing sensors. The method includes receiving a first condition to be used in determining whether to send a message and receiving data associated with a sensor. In some embodiments, the sensor is a radiation sensor. In some embodiments, the data associated the sensor comprises analyzed sensor data. In some embodiments, the data associated with the sensor comprises sensor metadata. In some embodiments, the message based on the formatting indicator comprises a portion of the sensor metadata. The method further includes determining whether the data associated with the sensor satisfies the first condition and in response to the determining that the data associated with the sensor satisfies the first condition associated with message, receiving a formatting indicator. The method further includes sending the message based on the formatting indicator. In some embodiments, the sending comprises sending the message to a government entity. In some embodiments, the sending comprises sending the message based on the formatting indicator to a destination based on a second condition being met.

Another embodiment is directed to a system for monitoring and managing sensors. The system includes a condition module configured to receive a condition associated with a message and a data module configured to receive data associated with a sensor. In some embodiments, the sensor is a complementary metal-oxide-semiconductor (CMOS) based radiation sensor. In some embodiments, the data associated with the sensor comprises sensor metadata. The system further includes a sending determination module configured to determine whether the data associated with the sensor satisfies the condition and a messaging module configured to format the message and send the message based on the data associated with the sensor satisfying the condition. In some embodiments, the sending determination module is further configured to determine a destination for the message based on a destination condition. In some embodiments, the messaging module is configured to format the message based on a template. In some embodiments, the messaging module is configured to incorporate a portion of the sensor metadata into the message based on the template. In some embodiments, the messaging module is configured to send the message to a service selected from the group consisting of a database, short message service (SMS), multimedia messaging service (MMS), instant messaging service, and an Extensible Markup Language (XML) based messaging service.

Another embodiment is directed to a non-transitory computer-readable storage medium having stored thereon, computer executable instructions that, if executed by a device, causes the device to perform a method for monitoring and managing sensors. The method includes receiving a condition to be used in determining whether to send a message and receiving data associated with a radiation sensor. In some embodiments, the condition comprises a heuristic. The data associated with the radiation sensor comprises sensor metadata. In some embodiments, the data associated with the radiation sensor further comprises analyzed sensor data. In some embodiments, the data associated with the radiation sensor comprises an indicator associated with a group of radiation sensor readings above a threshold. The method further includes determining whether the data associated with the radiation sensor satisfies the condition and in response to the determining that the data associated with the radiation sensor satisfies the condition associated with message, receiving a template. The method further includes sending the message based on the template and the metadata. In some embodiments, the template is a user configurable template. In some embodiments, the method further includes determining a destination of the message based on a destination condition, wherein the sending further comprises sending the message to the destination based on the destination.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an exemplary operating environment of an exemplary sensor based detection system in accordance with one embodiment.

FIG. 2 shows an exemplary data flow diagram in accordance with one embodiment.

FIG. 3 shows a block diagram of exemplary messaging dataflow in accordance with one embodiment.

FIG. 4 shows an exemplary flow diagram of a process for sending sensor data based communications in accordance with one embodiment.

FIG. 5 shows a block diagram of an exemplary computer system in accordance with one embodiment.

FIG. 6 shows a block diagram of another exemplary computer system in accordance with one embodiment.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “sending,” “querying,” “providing,” “accessing,” “associating,” “configuring,” “initiating,” “customizing”, “mapping,” “modifying,” “analyzing,” “displaying,” “updating,” “reconfiguring,” “restarting,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data, that are non-transitory. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security.

Embodiments are configured for receiving sensor associated data (e.g., sensor raw data, analyzed sensor data, sensor metadata, etc.) and sending messages based on a condition (e.g., rule, parameter, heuristics) and the sensor associated data. Embodiments are further configured for formatting the messaging (e.g., based on a template) according the destination of the message (e.g., Fusion Center). Embodiments may send human readable or machine readable messages. It is appreciated that the embodiments are described herein within the context of radiation detection and gamma ray detection merely for illustrative purposes and are not intended to limit the scope.

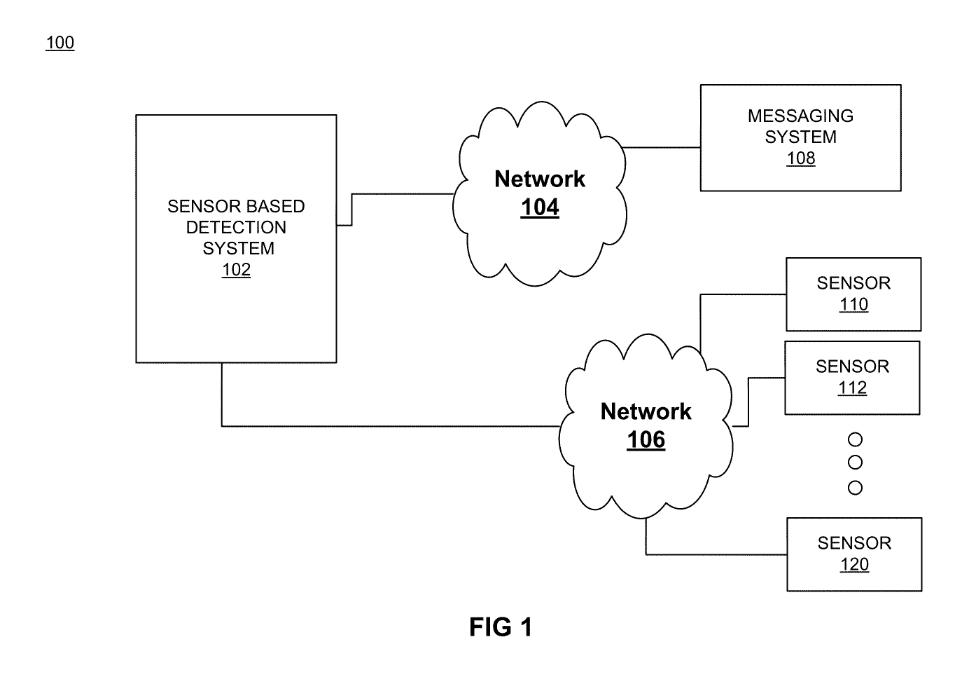

FIG. 1 shows an exemplary operating environment in accordance with one embodiment. The exemplary operating environment 100 includes a sensor based detection system 102, a network 104, a network 106, a messaging system 108, and sensors 110-120. The sensor based detection system 102 and the messaging system 108 are coupled to a network 104. The sensor based detection system 102 and messaging system 108 are communicatively coupled via the network 104. The sensor based detection system 102 and sensors 110-120 are coupled to a network 106. The sensor based detection system 102 and sensors 110-120 are communicatively coupled via network 106. The networks 104, 106 may include more than one network (e.g., intranets, the Internet, local area networks (LAN)s, wide area networks (WAN)s, etc.) and may be a combination of one or more networks including the Internet. In some embodiments, network 104 and network 106 may be a single network.

The sensors 110-120 detect a reading associated therewith, e.g., gamma radiation, vibration, etc., and transmit that information to the sensor based detection system 102 for analysis. The sensor based detection system 102 may use the received information and compare it to a threshold value, e.g., historical values, user selected values, etc., in order to determine whether a potentially hazardous event has occurred. In response to the determination, the sensor based detection system 102 may transmit that information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-120 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-120 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, surveillance cameras, etc. The sensors 110-120 may be video cameras (e.g., internet protocol (IP) video cameras) or purpose built sensors.

The sensors 110-120 may be fixed in location (e.g., surveillance cameras or sensors), semi-fixed (e.g., sensors on a cell tower on wheels or affixed to another semi portable object), or mobile (e.g., part of a mobile device, smartphone, etc.). The sensors 110-120 may provide data to the sensor based detection system 102 according to the type of the sensors 110-120. For example, sensors 110-120 may be CMOS sensors configured for gamma radiation detection. Gamma radiation may thus illuminate a pixel, which is converted into an electrical signal and sent to the sensor based detection system 102.

The sensor based detection system 102 is configured to receive data and manage sensors 110-120. The sensor based detection system 102 is configured to assist users in monitoring and tracking sensor readings or levels at one or more locations. The sensor based detection system 102 may have various components that allow for easy deployment of new sensors within a location (e.g., by an administrator) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-120 and components of a sensor based detection system 102 may be distributed over multiple systems (e.g., and virtualized) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, etc., and if so then the sensor based detection system 102 may determine a route or path of travel that dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, etc., or relative to a mixture of fixed and mobile sensors may similarly be determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-120. The GUI may be configured for indicating sensor readings, sensor status, sensor locations on a map, etc. The sensor based detection system 102 may allow review of past sensor readings and movement of sensor detected material or conditions based on stop, play, pause, fast forward, and rewind functionality of stored sensor values. The sensor based detection system 102 may also allow viewing of an image or video footage (e.g., motion or still images) corresponding to sensors that had sensor readings above a threshold (e.g., based on a predetermined value or based on ambient sensor readings). For example, a sensor may be selected in a GUI and video footage associated with an area within the sensor's range of detection may be displayed, thereby enabling a user to see an individual or person transporting hazardous material. According to one embodiment the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensors representations and/or indicators, which may include color coding, shapes, icons, flash rate, etc., according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the graphical user interface (GUI). The sensor based detection system 102 may allow a user (e.g., operator) to group multiple sensors together to create an event associated with multiple alerts from multiple sensors. For example, a code red event may be created when three sensors or more within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-120. The messaging system 108 may include one or more messaging systems or platforms which may include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. For example, national information exchange model (NIEM) compliant messaging may be used to report chemical, biological, radiological and nuclear defense (CBRN) suspicious activity reports (SARs) to report to government entities (e.g., local, state, or federal government).

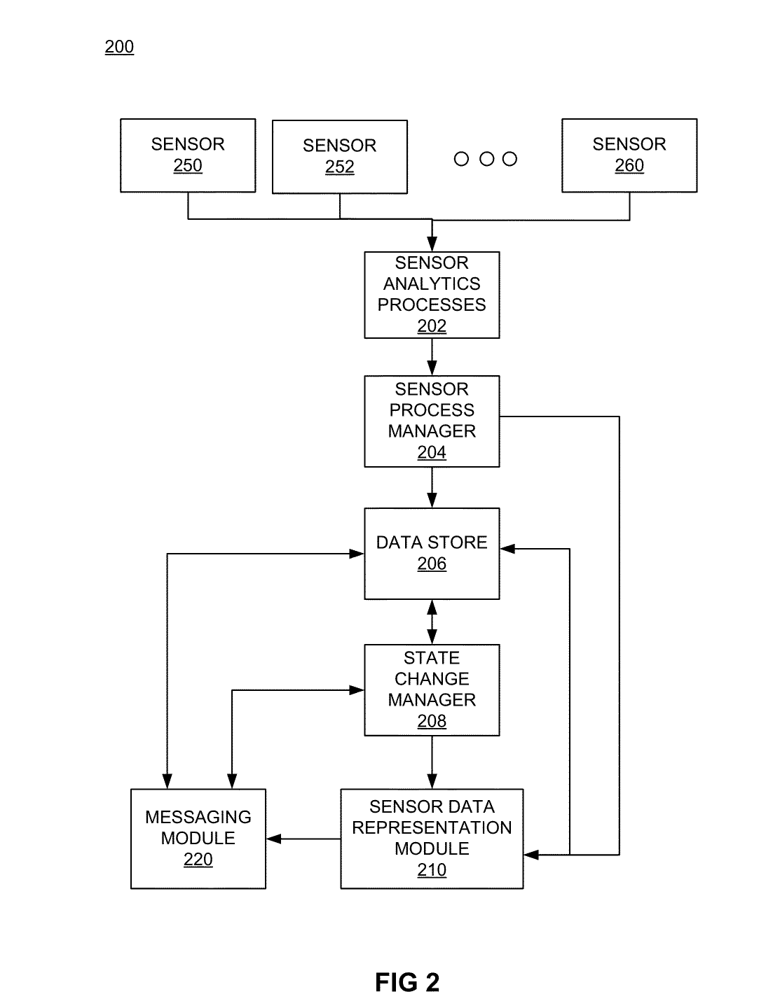

FIG. 2 shows an exemplary data flow diagram in accordance with one embodiment. Diagram 200 depicts the flow of data (e.g., sensor readings, raw sensor data, analyzed sensor data, etc.) associated with a sensor based detection system (e.g., sensor based detection system 102). Diagram 200 includes sensors 250-260, sensor analytics processes 202, a sensor process manager 204, a data store 206, a state change manager 208, a sensor data representation module 210, and messaging module 220. In some embodiments, the sensor analytics processes 202, the sensor process manager 204, the state change manager 208, and the sensor data representation module 210, and messaging module 220 may execute on one or more computing systems (e.g., virtual or physical computing systems). The data store 206 may be part of or stored in a data warehouse.

The sensors 250-260 may be substantially similar to sensors 110-120 and may be any of a variety of sensors as described above. The sensors 250-260 may provide data (e.g., as camera stream data, video stream data, etc.) to the sensor analytics processes 202.

The sensor process manager 204 is configured to initiate or launch sensor analytics processes 202. The sensor process manager 204 is configured to configure each instance or process of the sensor analytics processes 202 based on configuration parameters (e.g., preset, configured by a user, etc.). In some embodiments, the sensor analytics processes 202 may be configured by the sensor process manager 204 to organize sensor readings over particular time intervals (e.g., 30 seconds, one minute, one hour, one day, one week, one year). It is appreciated that the particular time intervals may be preset or it may be user configurable. It is further appreciated that the particular time intervals may be changed dynamically, e.g., during run time, or statically. In some embodiments, a process of the sensor analytics processes 202 may be executed for each time interval. The sensor process manager 204 may also be configured to access or receive metadata associated with sensors 250-260 (e.g., geospatial coordinates, network settings, user entered information, etc.).

The sensor process manager 204 receives analyzed sensor data from sensor analytics processes 202. The sensor process manager 204 may then send the analyzed sensor data to the data store 206 for storage. The sensor process manager 204 may further send metadata associated with sensors 250-260 for storage in the data store 206 with the associated analyzed sensor data. In some embodiments, the sensor process manager 204 may send the analyzed sensor data and metadata to the sensor data representation module 210. In some embodiments, the sensor process manager 204 sends the analyzed sensor data and metadata associated with sensors 250-260 to the sensor data representation module 210. It is appreciated that the information transmitted to the sensor data representation module 210 from the sensor process manager 204 may be in a message based format.

In some embodiments, the sensor analytics processes 202 may then send the analyzed sensor data to the data store 206 for storage. The sensor analytics processes 202 may further send metadata associated with sensors 250-260 for storage in the data store 206 with the associated analyzed sensor data.

The state change manager 208 may access or receive analyzed sensor data and associated metadata from the data store 206. The state change manager 208 may be configured to analyze sensor readings for a possible change in the state of the sensor. It is appreciated that in one embodiment, the state change manager 208 may receive the analyzed sensor data and/or associated metadata from the sensor analytics processes 202 directly without having to fetch that information from the data store 206 (not shown).

The state change manager 208 may determine whether a state of a sensor has changed based on current sensor data and previous sensor data. Changes in sensors state based on the sensor readings exceeding a threshold, within or outside of a range, etc., may be sent to a sensor data representation module 210 (e.g., on a per sensor basis, on a per group of sensors basis, etc.). For example, a state change of the sensor 252 may be determined based on the sensor 252 changing from a prior normal reading to an elevated reading (e.g., above a certain threshold, within an elevated reading, within a dangerous reading, etc.) In another example, the state of sensor 250 may be determine not to have changed based on the sensor 252 having an elevated reading within the same range as the prior sensor reading. In some embodiments, the various states of sensors and associated alerts may be configured by a sensor process manager 204. For example, the sensor process manager 204 may be used to configure thresholds, ranges, etc., that may be compared against sensor readings to determine whether an alert should be generated. For example, the sensors 205-260 may have five possible states: calibrating, nominal, elevated, potential, warning, and danger. It is appreciated that the configuring of the sensor process manager 204 may be in response to a user input. For example, a user may set the threshold values, ranges, etc., and conditions to be met for generating an alert. In some embodiments, color may be associated with each state. For example, dark gray may be associated with a calibration state, green associated with a nominal state, yellow associated with an elevated state, orange associated with a potential state, and red associated with an alert state. Light gray may be used to represent a sensor that is offline or not functioning.

In some embodiments, the state change manager 208 is configured to generate an alert or alert signal if there is a change in the state of a sensor to a new state. For example, an alert may be generated for a sensor that goes from a nominal state to an elevated state or a potential state. In some embodiments, the state change manager 208 includes an active state table. The active state table may be used to store the current state and/or previous and thereby the active state table is maintained to determine state changes of the sensors. The state change manager 208 may thus provide real-time sensing information based on sensor state changes.

In some embodiments, the state change manager 208 may determine whether sensor readings exceed normal sensor readings from ambient sources or whether there has been a change in the state of the sensor and generate an alert. For example, with gamma radiation, the state change manager 208 may determine if gamma radiation sensor readings are from a natural source (e.g., the sun, another celestial source, etc.) or other natural ambient source based on a nominal sensor state, or from radioactive material that is being transported within range of a sensor based on an elevated, potential, warning, or danger sensor state. In one exemplary embodiment, it is determined whether the gamma radiation reading is inside a safe range based on a sensor state of nominal or outside of the safe range based on the sensor state of elevated, potential, warning, or danger.

In some embodiments, individual alerts may be sent to an external system (e.g., a messaging system 108). For example, one or more alerts that occur in a certain building within time spans of one minute, two minutes, or 10 minutes may be sent to a messaging system. It is appreciated that the time spans that the alerts are transmitted may be preset or selected by the system operator. In one embodiment, the time spans that the alerts are transmitted may be set dynamically, e.g., in real time, or statically.

The sensor data representation module 210 may access or receive analyzed sensor data and associated metadata from the sensor process manager 204 or data store 206. The sensor data representation module 210 may further receive alerts (e.g., on a per sensor basis, on per location basis, etc.) based on sensor state changes determined by the state change manager 208.

The sensor data representation module 210 may be configured to render a graphical user interface depicting sensors, sensor state, alerts, sensor readings, etc. The sensor data representation module 210 may display one or more alerts, which occur when a sensor reading satisfies a certain condition visually on a map, e.g., when a sensor reading exceeds a threshold, falls within a certain range, is below a certain threshold, etc. The sensor data representation module 210 may thus notify a user (e.g., operator, administrator, etc.) visually, audibly, etc., that a certain condition has been met by the sensors, e.g., possible bio-hazardous material has been detected, elevated gamma radiation has been detected, etc. The user may have the opportunity to inspect the various data that the sensor analytics processes 202 have generated (e.g. mSv values, bio-hazard reading level values, etc.) and generate an appropriate event case file including the original sensor analytics process 202 data (e.g. raw stream data, converted stream data, preprocessed sensor data, etc.) that triggered the alert. The sensor data representation module 210 may be used (e.g., by operators, administrators, etc.) to gain awareness of any materials (e.g., radioactive material, bio-hazardous material, etc.) or other conditions that travel through or occur in a monitored area.

In some embodiments, the sensor data representation module 210 includes location functionality configured to show a sensor, alerts, and events geographically. The location functionality may be used to plot the various sensors at their respective location on a map within a graphical user interface (GUI). The GUI may allow for rich visual maps with detailed floor plans at various zoom levels, etc. The sensor data representation module 210 may send sensor data, alerts, and events to a messaging system (e.g., messaging system 108) for distribution (e.g., other users, safety officials, etc.).

Alerts from one or more sensors may be grouped, aggregated, represented, and/or indicated as an event. An event may thus be associated with one or more alerts from one or more sensors. The event may be determined based on one or more conditions, rules, parameters, or heuristics applied to one or more alerts. For example, a single alert could be a fluke or a blip in a sensor reading. When multiple alerts occur, however, there is a high likelihood that something more significant is taking place. For example, multiple alerts occurring within the same area or within a certain proximity of one another or facility may indicate that a hazardous material is present in that area. In another example, five alerts that happen within the preceding one minute within the same building and on the same floor may be aggregated into an event. The event may then be sent to an external system or highlighted on a graphical user interface.

In some embodiments, an operator may be able to mark an alert, or series of alerts, as an “event.” The sensor data representation module 210 may allow a user (e.g., operator, administrator, etc.) to group multiple sensors together, e.g., via a text block field, via a mouse selection, via a dropdown menu, etc., to create an event associated with multiple alerts from a group of selected sensors. For example, a code red event may be created when three sensors or more within twenty feet of one another and within the same physical space have a sensor reading that is at least 40% above historical values. In some embodiments, the sensor based detection system 102 may automatically group sensors together based on the geographical proximity of the sensors, e.g., the sensors of gates 1, 2, and 3 within terminal A at LAX airport may be grouped together due to their proximate location with respect to one another, e.g., physical proximity within the same physical space, whereas sensors in different terminals are not grouped because of their disparate locations. However, in certain circumstances sensors within the same airport may be grouped together in order to monitor events at the airport as a whole and not at more granular level of terminals, gates, etc. It is further appreciated that other criteria may be used to group sensors and events together, e.g., sensor types, sensor readings, sensor proximity relative to other sensors, sensor locations, common paths in a structure past sensors, etc.

Representation of sensors (e.g., icons, images, shapes, rows, cells, etc.) may be displayed on a map and be configured for selection to be associated with an event. For example, five alerts with respect to five associated sensors within a particular vicinity may be displayed and an operator may select (e.g., highlight, click on, etc.) the five sensors (e.g., via lasso selection, click and drag selection, click selection, etc.) to group the sensors as an event. Alerts from the five sensors may then be displayed or sent as an event. A condition may also be applied to the group of five sensors such that an event is triggered based on one or more of the sensors in the group of five sensors satisfying a condition (e.g., reaching particular radiation level, exceeding a range of radiation readings, etc.).

In some embodiments, the sensor data representation module 210 may automatically select sensors to be associated as an event. For example, sensors within a 10 meters radius of each other within the same building can automatically be grouped so that alerts from the sensors will be indicated as an event.

The sensor data representation module 210 may access or receive one or more conditions, parameters, or heuristics via a graphical user interface, as input by an operator for instance, that may be used to configure the sensor process manager 204/state change manager 208 in determining an event. The one or more conditions, parameters, or heuristics may be received via the graphical user interface of a sensor data representation module 210, a sensor process manager 204, state change manager 208. The sensor data representation module 210 may determine whether an event has occurred based on an evaluation (e.g., a comparison, an algorithm, etc.) of the analyzed sensor data, the sensor metadata, and the one or more conditions, parameters, or heuristics. For example, sensors on a particular floor of a building may be selected as an event based on the associated location metadata of the sensors.

In another example, the parameters, conditions, or heuristics may be when metadata of sensors has substantially similar values or is within a range of particular values and/or the sensors are associated within a particular temporal time spans (e.g., number of minutes or hours interval over which sensor data is analyzed). Exemplary parameters may include, but are not limited to, building name, floor level, room number, geospatial coordinates within a given range (e.g., distance between sensors, proximity of sensors, etc.), sensor vendors, sensor type, sensor properties, sensor configuration, etc.

The heuristics may include a geographical range (e.g., sensors within a 20-30 meter range, larger range, etc.) or may be based on the time of travel or distance between particular sensors, etc. For example, if it normally takes people 30 minutes to pass through a security checkpoint then if any sensor within the security checkpoint has an alert state for a one minute interval or for a 30 minute interval an event based on the heuristics may be reported. An elevated or alert sensor state of 30 minutes may correspond to a particularly high radiation level that may be worth further investigation.

The heuristics may further include a distance between the sensors and proximity of the sensors. That is, the heuristics may be based on the time, distance, and proximity of the sensors. For example, if two adjacent sensors are sufficiently distant from each other so that radioactive material does not set off both sensors and a person traveling past the sensors would take at least 10 minutes to walk past both sensors, when alerts are generated based on both sensors in a particular order within 10 minutes, an associated event is generated.

An event and associated parameters, conditions, etc., may be based on the geographic proximity of the sensors. An event may thus allow focusing a user's attention (e.g., operator, administrator, etc.) on particular sensor data for a particular area. Metadata associated with the sensors including location, etc., may be used for event determination. For example, a single sensor based alert may be caused by an abnormality, background radiation, etc., while alerts from three, five, or seven sensors within 10 meters of each other may be indicative of a dangerous condition (e.g., hazardous material, hazardous cloud, etc.) that should be further analyzed or further attention directed thereto.

Based on determining that an event has occurred, an indicator may be output by the sensor data representation module 210. In some embodiments, the indicator may be output visually, audibly, or via a signal to another system (e.g., messaging system 108).

In some embodiments, an event may be configured with a parameter specifying where an event indicator should be sent. For example, an event indicator may be displayed in the GUI or the event indicator may be sent to an external system (e.g., messaging system 108).

The indicator may be based on one or more alerts from one or more sensors or an event based on alerts from multiple sensors. The events may be based on groups of sensors selected manually (e.g., via a GUI, command line interface, etc.) or automatically (e.g., based on an automatic grouping determined by the sensor based detection system 102), or based on heuristics. In some embodiments, the indicator (e.g., alert, event, message, etc.) may be output to a messaging system (e.g., messaging system 108 or messaging module 214). For example, the indicator may be output to notify a person (e.g., operator, administrator, safety official, etc.) or group of persons (e.g., safety department, police department, fire department, homeland security, etc.).

The sensor data representation module 210 may have various tools to “replay” after an event has occurred. The sensor data representation module 210 may further allow an operator to configure the sensor data representation module 210 to send alerts to external entities. For example, the operator can configure an XML interface to forward alerts and events to a local Fusion Center (e.g., of the federal government, another government office, etc.). The operator may further configure an SMS gateway or even a Twitter™ account to send alerts or events to.

In some embodiments, one or more functionalities of a sensor based detection system (e.g., sensor based detection system 102) may be invoked upon determining that an event has occurred. For example, a message may be sent if an event has occurred, a determination of the path of travel of a hazardous material or condition may be determined if an event has occurred, video may be displayed associated with sensor readings if an event has occurred, an alarm may be signaled if an event has occurred, etc.

The messaging module 220 is configured to send messages to other systems or messaging services including, but not limited to, a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. In one example, national information exchange model (NIEM) compliant messaging may be used to report chemical, biological, radiological and nuclear defense (CBRN) suspicious activity reports (SARs) to report to government entities (e.g., local, state, or federal government). It is appreciated that the messages may be formatted to comply with the requirement/standards of the messaging service used. For example, as described above a message may be formed into the NIEM format in order to report a CBRN event.

In some embodiments, the messaging module 220 (e.g., in conjunction with sensor data representation module 210) may be configured to send alerts and event to external end-points (e.g., messaging services or systems, governmental entities, databases, etc.). For example, an operator could configure an XML interface to forward all alerts to a local Fusion Center. In another example, the operator can configure an SMS gateway or even a Twitter™ account to receive messages (e.g., including alerts and/or events).

The messaging module 220 may access, receive, etc. information from a data store 206, a state change manager 208, and/or a sensor data representation module 210. The data store 206 may receive and store alerts from a state change manager 208 and events from a sensor data representation module 210. In some embodiments, the data store 206 may include templates, which are used for assembling a message (e.g., including formatting a message). In some embodiments, the messaging module 220 receives alerts, events, and metadata from the data store 206. In some embodiments, the data store 206 may receive data (e.g., records, log entries, etc.) associated with messages sent by the messaging module 220. In some embodiments, the messaging module 220 receives alerts from the state change manager 208. In some embodiments, the messaging module 220 receives alerts, events, and metadata from the sensor data representation module 210.

The messaging module 220 may access, receive, etc. alert and event information from the data store 206, the state change manager 208, and the sensor data representation module 210 and apply rules, parameters, heuristics, and/or conditions to determine whether a message based on the alert or event is to be sent. In some embodiments, alerts or events may be escalated (e.g., by a user, operator, administrator, etc.) via the messaging module 220 to appropriate authorities (e.g., local, state, or federal government). It is appreciated that the alerts or events may be further escalated automatically and based on heuristics. It is appreciated that the alerts or events may further be escalated, for example, by sending additional messages to the same responsible party, the responsible party's respective superior, or a different entity if the original messages that were transmitted are not processed or responded to in a timely fashion.

Some embodiments allow a first set of rules to be used for grouping alerts into events and a second set of rules to be used to determine whether to send a message based on the event or an alert. For alerts, for example, the location, the time of the alert, or repeat intervals at which the alert happened may be used to determine whether to send a message based on the alert. For events, for example, the heuristics, as described above with respect to events, may be applied to determine whether to send a message based on the event. In some embodiments, an alert queue and an event queue of the messaging module 220 are used to receive alerts and events upon which the rules, parameters, conditions, or heuristics, are applied to determine whether to send a message based on the alert or event. In some embodiments, a destination (e.g., messaging system, data store, etc.) may be selected based on rules, conditions, parameters, or heuristics. For example, NIEM may be the desired messaging format for a governmental agency as its destination to report a chemical, a biological, and/or a radiological event.

The messaging module 220 may be configured to act as an interface to third parties and third party systems and format a message accordingly. The messaging module 220 may support a variety of formats and may further support adding additional formats. In some embodiments, the messaging module 220 supports use of templates for message formatting. For example, an XML message may be formatted using one or more templates including variables or metadata keys. The metadata keys may be placeholders or variables for sensor metadata within the message and used for inserting sensor metadata associated with the alert or event prior to sending the message. For example, an XML message template may include “Warning: Sensor: <xsl:value-of select=”sensor-name“/> located at <xsl:value-of select=”sensor-location“/> has a reading of <xsl:value-of select=”sensor-reading“/>.” In some embodiments, the messaging module 220 may be configured to display a graphical user interface for creating a message template.

A message may further be sent via a telephone call (e.g., to a mobile device) or to a pager. For example, text to speech may be used to communicate the message via a telephone call. A message may also be communicated to a controller board (e.g., dry contact controller board) or another electronic system (e.g., lighting system, alarm system, or emergency evacuation system).

In some embodiments, radiation sensor based data (e.g., alerts and events) or other sensor based data is evaluated to determine whether a message is to be sent. For example, if radiation sensor based data indicates that a dosage of radiation above a particular mSv level has been detected, a message may be sent based on the alert associated with the radiation dosage in a NIEM format to a Fusion Center.

Embodiments are thus configured to send messages based on sensor based detection of a variety of materials, conditions, etc. For example, messages may be sent based on detection of biological, chemical, or radioactive, etc. threats. As another example, a message may be sent based on the detection of certain levels of radiation or bio-hazardous material or levels of radiation (e.g., greater than 1 Sv) or bio-hazardous material that varies outside of a specified limit or range (e.g., 300 mSV-900 mSv).

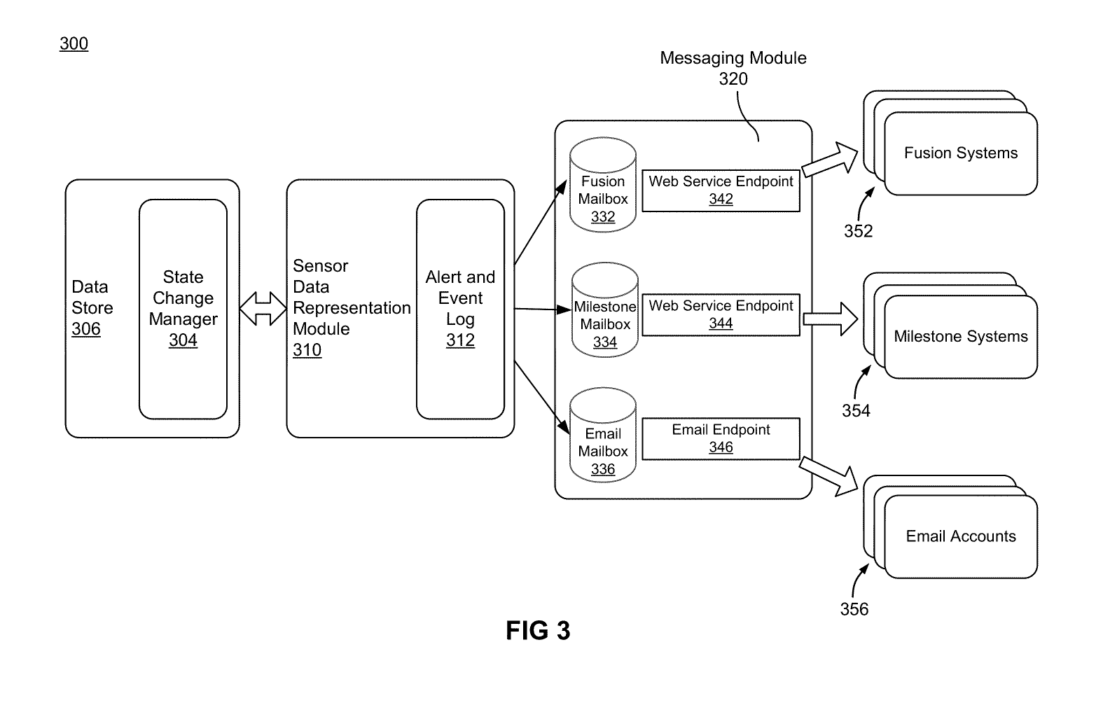

FIG. 3 shows a block diagram of exemplary messaging dataflow in accordance with one embodiment. FIG. 3 depicts exemplary messaging based on alerts and/or events. Diagram 300 includes a data store 306, a sensor data representation module 310, a messaging module 320, fusion systems 352, a milestone systems 354, and email accounts 356.

The data store 306 may include sensor data, analyzed sensor data, and sensor metadata (e.g., including a sensor's name, description, location, longitude, latitude, building, floor, campus, description, manufacturer, etc.). In some embodiments, the data store 306 may be a data warehouse. In some embodiments, the data store 306 may include a state change manager 304, which is configured to determine whether a state of a sensor has change and generate an alert based on the state change of a sensor.

In some embodiments, the data store 306 is configured to function as an alert service configured to provide the current alert status for each sensor time path or time interval, real time alert status changes for sensor time paths, and event reporting. The sensor data representation module 310 may receive the current alert state for each sensor time path and events from the data store 306. In some embodiments, events are queued up and retained in a data store (e.g., data store 306) until consumed by the sensor data representation module 310.

The sensor data representation module 310 is configured to receive alerts from the data store 306. The sensor data representation module 310 is configured to display sensor related information and information associated with the alerts. The sensor data representation module 310 may further determine events based on criteria (e.g., including rules, conditions, parameters, and heuristics) of one or more alerts. The events and alerts may be stored in alert and event log 312 and sent to the data store 306 for storage.

In some embodiments, the sensor data representation module 310 is configured to facilitate (e.g., push) alerts to an alerts and events log module 312. The alerts may then be displayed as part of an alerts log area of a graphical user interface. The alerts may also be displayed as part of a locations area of a graphical user interface. In some embodiments, the display of the alert information may be configured to (e.g., via WebSocket technology) to allow a server to push data to a browser, as opposed to the browser polling for new data from the server (e.g., via Asynchronous JavaScript™ and XML (AJAX) calls).

The messaging module 320 may access, receive, etc., alerts and events from the sensor representation module 310. The messaging module 320 may determine based on criteria (e.g., criteria specific to the messaging module 320) whether alerts and/or events and associated information will be sent to various destinations.

In some embodiments, the messaging module 320 includes a fusion mailbox 332, a milestone mailbox 334, an email mailbox 336, a web service endpoint 342, a web service endpoint 344, and an email endpoint 346. In some embodiments, the fusion mailbox 332, the milestone mailbox 334, and the email mailbox 336 may be data stores. The messaging module 320 may determine based on criteria (e.g., including conditions, rules, parameters, heuristics, etc., as described above) to send a message via the fusion mailbox 332, the milestone mailbox 334, and the email mailbox 336. The messaging module 320 may format the message (e.g., based on a template), as described above, according to the mailbox that will be used for sending the message.

The messaging module 320 may send messages from the fusion mailbox 332 via a web service endpoint 342 to fusion systems 352 (e.g., including Fusion Center). The messaging module 320 may send messages from the milestone mailbox 334 via a web service endpoint 344 to the milestone systems 354 (e.g., or other security systems). The messaging module 320 may send messages from the email mailbox 336 via an email endpoint 346 to email accounts 356. In some embodiments, the email accounts 356 may be email accounts on external systems.

In some embodiments, the messaging module 320 may receive a signal from the sensor data representation module 310 to route and distribute alert and event data to various external systems. In some embodiments, the messaging module 320 may be part of or embedded in the sensor data representation module 310. In some embodiments, messaging module 320 may be a stand alone application.

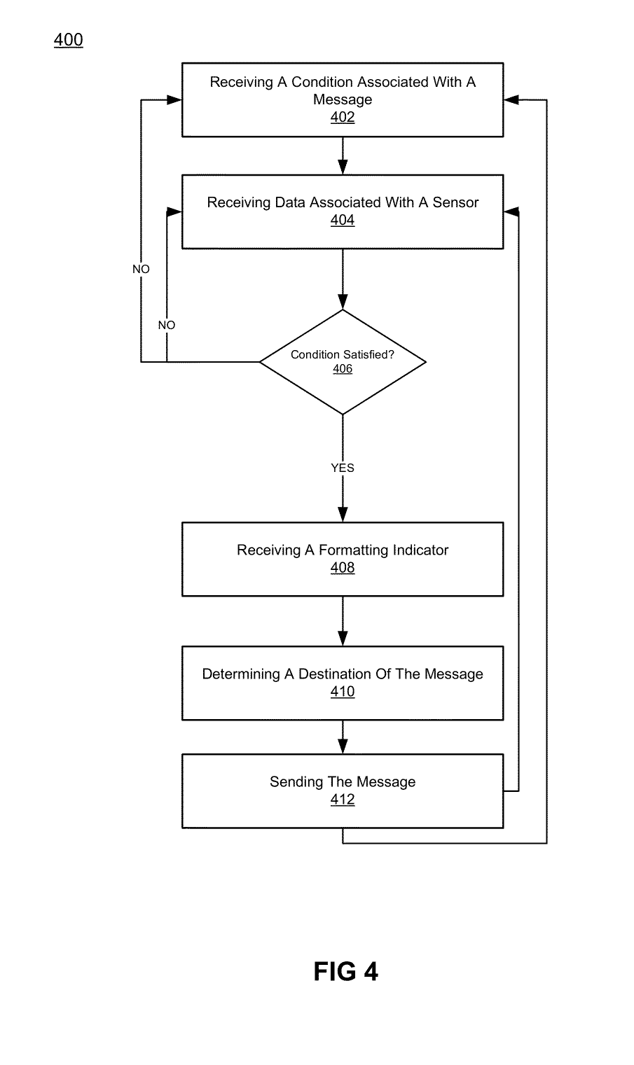

FIG. 4 shows an exemplary flow diagram of a process for sending sensor data based communications in accordance with one embodiment. In some embodiments, FIG. 4 depicts a process for sending messages based on sensor data.

At block 402, a condition associated with a message is received. The condition may be a parameter, rule, heuristic, etc., as described above. The condition may be used to determine whether to send the message and to determine where to send the message. For example, the condition may include sending radiation sensor readings above a particular mSv level to one or more Fusion centers.

At block 404, data associated with a sensor is received. In some embodiments, the sensor is a radiation sensor. In some embodiments, the data associated the sensor comprises analyzed sensor data. In some embodiments, the data associated with the sensor comprises sensor metadata. In some embodiments, the data associated with the sensor comprises an indicator associated with a group of radiation sensor readings above or below a threshold (e.g., an event), inside or outside range (e.g., predetermined, static, or dynamic), and/or a combination thereof.

At block 406, whether the data associated with the sensor satisfies the condition associated with the message is determined. If the data associated with the sensor satisfies the condition, block 408 may be performed. If the data associated with the sensor does not satisfy the condition, blocks 402 or 404 may optionally be performed.

At block 408, a formatting indicator is received. The formatting indicator may be a template or other formatting associated information that can be used to format the message. The formatting indicator may have information associated with the format that the destination of a message will be capable of receiving and processing. For example, the formatting indicator may indicate that the message should be sent in an XML or NIEM format. In some embodiments, the formatting indicator is received in response to determining that the data associated with the sensor satisfies the condition associated with message.

At block 410, a destination for the message is determined based on a destination condition. For example, a destination condition may indicate that radiation readings above a specified level are sent to a government department or entity (e.g., Fusion Center) while radiation readings below the specified level are sent to local authorities (e.g., local or state government).

At block 412, the message is sent based on the formatting indicator. In some embodiments, the formatting indicator is a template. In some embodiments, the message based on the formatting indicator comprises a portion of the sensor metadata. In some embodiments, the template is a user configurable template (e.g., configurable via a graphical user interface). In some embodiments, the sending comprises sending the message to a government entity (e.g., a Fusion Center). In some embodiments, the sending further comprises sending the message in a format based on the destination or sending the message via a communication service based on the destination. In some embodiments, the sending comprises sending the message based on the formatting indicator to a destination based on a second condition associated with the message. Blocks 402 and 404 may then be optionally performed.

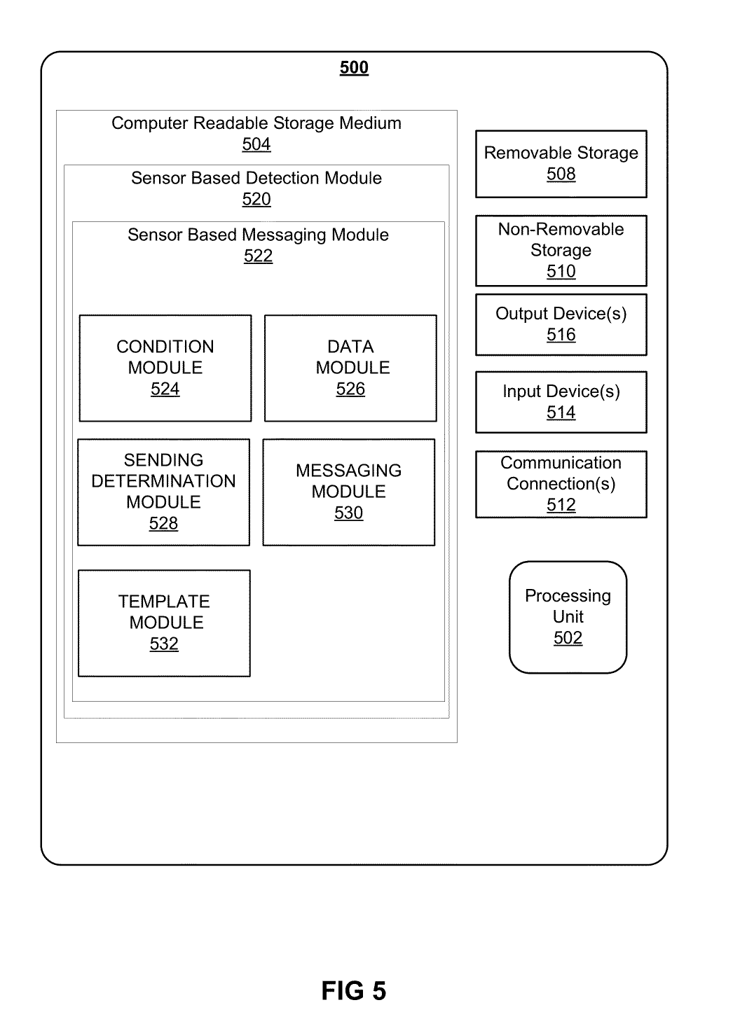

Referring now to FIG. 5, a block diagram of an exemplary computer system in accordance with one embodiment is shown. With reference to FIG. 5, an exemplary system module for implementing embodiments disclosed above, such as the embodiments described in FIGS. 1-4. In some embodiments, the system includes a general purpose computing system environment, such as computing system environment 500. The computing system environment 500 may include, but is not limited to, servers, desktop computers, laptops, tablets, mobile devices, and smartphones. In its most basic configuration, the computing system environment 500 typically includes at least one processing unit 502 and computer readable storage medium 504. Depending on the exact configuration and type of computing system environment, computer readable storage medium 504 may be volatile (such as RAM), non-volatile (such as ROM, flash memory, etc.) or some combination of the two. Portions of computer readable storage medium 504 when executed may receive sensor associated data (e.g., sensor raw data, analyzed sensor data, sensor metadata, etc.) and send messages based on a condition (e.g., rule, parameter, heuristics) and the sensor associated data (e.g., process 400).

Additionally in various embodiments, the computing system environment 500 may also have other features/functionality. For example, the computing system environment 500 may also include additional storage (removable and/or non-removable) including, but not limited to, magnetic or optical disks or tape. Such additional storage is illustrated by removable storage 508 and non-removable storage 510. Computer storage media includes volatile and nonvolatile, removable and non-removable media implemented in any method or technology for storage of information such as computer readable instructions, data structures, program modules or other data. Computer readable medium 504, removable storage 508 and nonremovable storage 510 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by the computing system environment 500. Any such computer storage media may be part of the computing system environment 500.

In some embodiments, the computing system environment 500 may also contain communications connection(s) 512 that allow it to communicate with other devices. Communications connection(s) 512 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 512 may allow the computing system environment 500 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that the communication connection(s) 512 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, the computing system environment 500 may also have input device(s) 514 such as keyboard, mouse, a terminal or terminal emulator (either directly connected or remotely accessible via telnet, SSH, HTTP, SSL, etc.), pen, voice input device, touch input device, remote control, etc. Output device(s) 2016 such as a display, a terminal or terminal emulator (either directly connected or remotely accessible via telnet, SSH, HTTP, SSL, etc.), speakers, LEDs, etc. may also be included.

In one embodiment, the computer readable storage medium 504 includes a sensor based detection module 520. The sensor based detection module 520 is configured for monitoring and management of a plurality of sensors and associated analytics (e.g., sensor based detection system 102). The sensor based detection module 520 includes a sensor based messaging module 522. The sensor based messaging module 522 is configured for receiving sensor associated data (e.g., raw sensor data, analyzed sensor data, sensor metadata, etc.) and sending messages based on the sensor associated data.

The sensor based messaging module 522 includes a condition module 524, a data module 526, a sending determination module 528, a messaging module 530, and a template module 532. The condition module 524 is configured for receiving a condition associated with a message. The condition may include rules, parameters, heuristics that may be compared to data associated with a sensor (e.g., alerts, events, raw sensor data, analyzed sensor data, sensor metadata) to determine whether a message based on the sensor associated data is to be sent. In some embodiments, the sensor is a complementary metal-oxide-semiconductor (CMOS) based radiation sensor.

The data module 526 is configured to receive data associated with a sensor. The data associated with the sensor may include one or more alerts, one or more events, raw sensor data, analyzed sensor data, sensor metadata, etc. The sending determination module 528 is configured to determine whether the data associated with the sensor satisfies a condition. The sending determination module 528 may determine whether the data associated with the sensor satisfies the condition based on comparing the condition to the data associated with the sensor. In some embodiments, the sending determination module 528 is further configured to determine a destination for the message based on a destination condition.

The messaging module 530 is configured to format the message and send the message based on the data associated with the sensor satisfying the condition. In some embodiments, the messaging module 530 is configured to format the message based on a template. In some embodiments, the messaging module 530 is configured to incorporate a portion of the sensor metadata into the message based on the template. In some embodiments, the messaging module 530 is configured to send the message to a service selected from the group consisting of a database, short message service (SMS), multimedia messaging service (MMS), instant messaging service, and an Extensible Markup Language (XML) based messaging service.

The template module 532 is configured for accessing, receiving, etc. a template configured for formatting a message. The template module 532 may further be configured for creation, customization, etc. of a template (e.g., via a graphical user interface).

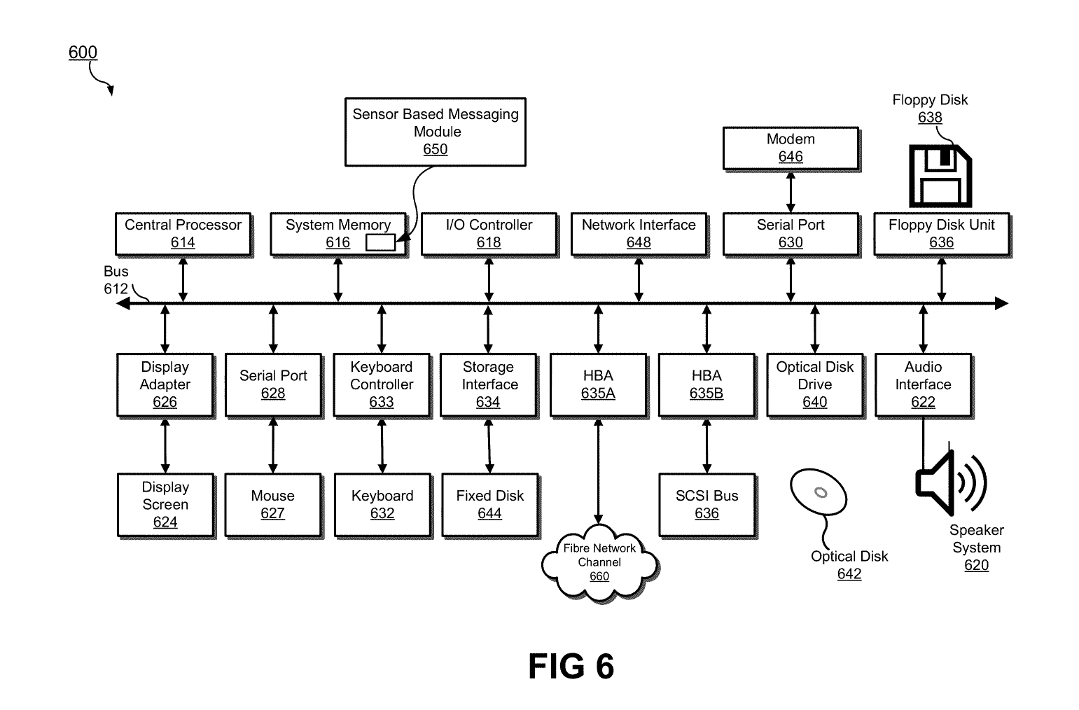

Referring now to FIG. 6, a block diagram of another exemplary computer system in accordance with one embodiment is shown. FIG. 6 depicts a block diagram of a computer system 600 suitable for implementing the present disclosure. Computer system 600 includes a bus 612 which connects the major subsystems of the computer system 600, such as a central processor 614, a system memory 616 (typically RAM, but which may also include ROM, flash RAM, or the like), an input/output controller 618, an external audio device, such as a speaker system 620 via an audio output interface 622, an external device, such as a display screen 624 via a display adapter 626, serial ports 628 and 630, a keyboard 632 (interfaced with a keyboard controller 633), a storage interface 634, a floppy disk drive 636 operative to receive a floppy disk 638, a host bus adapter (HBA) interface card 635A operative to connect with a Fibre Channel network 660, a host bus adapter (HBA) interface card 635B operative to connect to a Small Computer System Interface (SCSI) bus 636, and an optical disk drive 640 operative to receive an optical disk 642. Also included are a mouse 627 (or other point-and-click device, coupled to bus 612 via serial port 628), a modem 646 (coupled to bus 612 via serial port 630), and a network interface 648 (coupled directly to bus 612).

It is appreciated that the network interface 648 may include one or more Ethernet ports, wireless local area network (WLAN) interfaces, etc., but is not limited thereto. System memory 616 includes a sensor based messaging module 650, which is configured for receiving sensor associated data (e.g., raw sensor data, analyzed sensor data, sensor metadata, etc.) and sending messages based on the sensor associated data. According to one embodiment, the sensor based messaging module 650 may include other modules for carrying out various tasks (e.g., modules of FIG. 5). It is appreciated that the sensor based messaging module 650 may be located anywhere in the system and is not limited to the system memory 616. As such, residing within the system memory 616 is merely exemplary and not intended to limit the scope of the embodiments. For example, parts of the sensor based messaging module 650 may be located within the central processor 614 and/or the network interface 648 but are not limited thereto.

The bus 612 allows data communication between the central processor 614 and the system memory 616, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 600 are generally stored on and accessed via a computer readable medium, such as a hard disk drive (e.g., fixed disk 644), an optical drive (e.g., optical drive 640), a floppy disk unit 636, or other storage medium. Additionally, applications can be in the form of electronic signals modulated in accordance with the application and data communication technology when accessed via network modem 646 or network interface 648.

The storage interface 634, as with the other storage interfaces of computer system 600, can connect to a standard computer readable medium for storage and/or retrieval of information, such as a fixed disk drive 644. A fixed disk drive 644 may be a part of computer system 600 or may be separate and accessed through other interface systems. The network interface 648 may provide multiple connections to networked devices. Furthermore, a modem 646 may provide a direct connection to a remote server via a telephone link or to the Internet via an Internet service provider (ISP). The network interface 648 provides one or more connections to a data network, which may consist of any number of other network-connected devices. The network interface 648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, not all of the devices shown in FIG. 6 need to be present to practice the present disclosure. The devices and subsystems can be interconnected in different ways from that shown in FIG. 6. Code to implement the present disclosure can be stored in computer-readable storage media such as one or more of system memory 616, fixed disk 644, optical disk 642, or floppy disk 638. The operating system provided on computer system 600 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

What is claimed is:

1. A method comprising:
receiving a first condition to be used in determining whether to send a message;
receiving data associated with a sensor;
determining whether the data associated with the sensor satisfies the first condition;
in response to the determining that the data associated with the sensor satisfies the first condition associated with message, receiving a formatting indicator; and
sending the message based on the formatting indicator.

2. The method as described in claim 1, wherein the sensor is a radiation sensor.

3. The method as described in claim 1, wherein the data associated the sensor comprises analyzed sensor data.

4. The method as described in claim 1, wherein the data associated with the sensor comprises sensor metadata.

5. The method as described in claim 4, wherein the message based on the formatting indicator comprises a portion of the sensor metadata.

6. The method as described in claim 1, wherein the sending comprises sending the message to a government entity.

7. The method as described in claim 1, wherein the sending comprises sending the message based on the formatting indicator to a destination based on a second condition being met.

8. A system comprising:
a condition module configured to receive a condition associated with a message;
a data module configured to receive data associated with a sensor;
a sending determination module configured to determine whether the data associated with the sensor satisfies the condition; and
a messaging module configured to format the message and send the message based on the data associated with the sensor satisfying the condition.

9. The system of claim 8, wherein the data associated with the sensor comprises sensor metadata.

10. The system of claim 9, wherein the messaging module is configured to format the message based on a template.

11. The system of claim 10, wherein the messaging module is configured to incorporate a portion of the sensor metadata into the message based on the template.

12. The system of claim 8, wherein the messaging module is configured to send the message to a service selected from the group consisting of a database, short message service (SMS), multimedia messaging service (MMS), instant messaging service, and an Extensible Markup Language (XML) based messaging service.

13. The system of claim 8, wherein the sensor is a complementary metal-oxide-semiconductor (CMOS) based radiation sensor.

14. The system of claim 8, wherein the sending determination module is further configured to determine a destination for the message based on a destination condition.

15. A non-transitory computer-readable storage medium having stored thereon, computer executable instructions that, if executed by a device, causes the device to perform a method comprising:
receiving a condition to be used in determining whether to send a message;
receiving data associated with a radiation sensor, wherein the data associated with the radiation sensor comprises sensor metadata;
determining whether the data associated with the radiation sensor satisfies the condition;
in response to the determining that the data associated with the radiation sensor satisfies the condition associated with message, receiving a template; and
sending the message based on the template and the metadata.

16. The non-transitory computer-readable storage medium of claim 15, wherein the data associated with the radiation sensor further comprises analyzed sensor data.

17. The non-transitory computer-readable storage medium of claim 15, wherein the template is a user configurable template.

18. The non-transitory computer-readable storage medium of claim 15, wherein the condition comprises a heuristic.

19. The non-transitory computer-readable storage medium of claim 15, wherein the data associated with the radiation sensor comprises an indicator associated with a group of radiation sensor readings above a threshold.

20. The non-transitory computer-readable storage medium of claim 19, wherein the method further comprises:
determining a destination of the message based on a destination condition, wherein the sending further comprises sending the message to the destination based on the destination.
